(19) United States
(12) Patent Application Publication
(10) Pub. No.: US 2005/0182696 A1
(43) Pub. Date: Aug. 18, 2005

(54) System and method for automatically controlling inventory

(76) Inventors: Leonard Shatzkin, Croton-on-Hudson, NY (US); Eleanor Oshry Shatzkin, Croton-on-Hudson, NY (US)

Correspondence Address: Carter, DeLuca, Farrell & Schmidt, LLP, 445 Broad Hollow Road, Suite 225, Melville, NY, 11747, US

(21) Appl. No.: 11/039,574

(22) Filed: Jan. 20, 2005

Related U.S. Application Data
(62) Division of application No. 09/957,886, filed on Sep. 21, 2001.
(60) Provisional application No. 60/234,401, filed on Sep. 21, 2000.

(51) Int. Cl. G06F 17/60

(52) U.S. Cl. 705/28

(57) ABSTRACT

A method and system is provided for automatically controlling inventory. One or more point-of-sale businesses records sales and receipts for each item of inventory and transmits that information periodically (for example daily) to a database in a computer. This computer has software that acts as a “virtual buyer” in the sense that it implements set(s) of rules for the items and determines a target inventory for each item at each location. This information is then compared to each current inventory that is also kept current in a database. If the current inventory for that item at that location is less than the target inventory, then an order for more units of that item is generated to bring the current inventory up to the target inventory. Also, if the current inventory exceeds the target inventory for an item at one or more of the point-of-sale businesses, then instructions to return units of that item to the point-of-distribution may be generated.

### PRIORITY

This application claims priority to a provisional application entitled “System and Method for Automatically Controlling Inventory” filed with the United States Patent and Trademark Office on Sep. 21, 2000 and assigned U.S. Ser. No. 60/234,401.

### BACKGROUND OF THE INVENTION

1. Field of the Invention

The present invention relates generally to improving business efficiency, and in particular to a system and method for automatically controlling the inventory of a point-of-sale business to maximize return on investment in inventory.

2. Description of the Related Art

Ordering and inventory control are critical to the efficient and profitable operation of a point-of-sale business (e.g., retail store). One way of maximizing the return on investment (ROI) for a point-of-sale business is to minimize the investment in inventory to allow the business to either invest in a broader range of products or to simply obtain an optimum or near optimum return on current inventory.

In order to implement a strategy of maintaining inventory levels at a minimum at a point-of-sale location stocking a broad range of products, a large number of frequent buying decisions need to be made. In general, the more frequently the level of inventory on any product is adjusted to reflect immediate variations in rate of sale, the more likely the inventory level will produce maximum ROI. Although a skilled person can make buying decisions with care and intelligence by weighing pertinent factors, for some businesses there are inherent disadvantages in making buying decisions in this manner. One disadvantage is that human buyers are limited in the number of decisions they can make in a short span of time. For a point-of-sale business selling a broad range of products, the number of decisions that need to be made by a buyer in a short period of time can be very large. In particular, if the business is trying to implement a specific buying strategy such as, for example, a strategy of maintaining a minimum inventory by placing frequent orders for smaller quantities, then the limited ability of a buyer to continually make a large number of buying decisions can hinder implementation of the strategy.

Another drawback to using buyers is their associated costs. Buyers are expensive. Each buying decision made by a person takes a finite amount of time and therefore has an associated finite cost. In the aggregate, such costs can prove to be considerable.

Also, buyers are not as sensitive to sales events as is true for an automated system. When examining the sales of many thousands of items, the items with only occasional sales might be overlooked.

Finally, buyers are inconsistent. Although management can dictate that a specific strategy for buying is to be implemented, different buyers will make different decisions in the same circumstances and the same buyer will make different decisions in the same circumstances on different days.

Therefore, what is needed is a method for making automatic buying decisions without human intervention, which overcomes the afore-stated disadvantages.

### SUMMARY OF THE INVENTION

It is, therefore, an object of the present invention to provide an automatic inventory control system and associated method for making automatic stocking decisions including buying and returning products stocked at a point-of-sale business. The method is generally based on a mathematical set of rules designed to maximize the return on investment for each stocked item by maximizing stock turn (i.e., sales divided by average inventory) for each item.

It is another object of the present invention to provide a system and method that balances a limited investment in inventory for one or more items with a rapid replenishment of inventory to avoid missed sales.

To achieve the above objects, there is provided an automatic inventory control system and associated method which implements a mathematical set of rules to calculate a target inventory for a plurality of stocked items at a point-of-sale location. A single set of mathematical rules can be implemented for every product or a different set of rules may be implemented for each product. The set of mathematical rules is optimized to maximize the return on investment subject to initially defined constraints. For example, one constraint concerns a trade-off, which exists between minimizing inventory levels and lost sales due to out-of-stock events. The set of rules can be adjusted to provide a desired compromise. It is further contemplated that the system and method of the present invention may only be used for a subset of products at a point-of-sale business. The system automatically reorders items to maintain the inventory level at a target inventory level for each stocked item. Unlike prior art systems which predict or forecast demand, the method of the present invention does not utilize forecasting or predictive methods, instead re-orders or returns are determined solely as a function of past sales which occur over some continuous time interval or period (e.g., past day, past 3 days, past week, etc.). The set of mathematical rules may be based on several factors including recent sales history on an item-by-item basis at each point-of-sale location.

### BRIEF DESCRIPTION OF THE DRAWINGS

The above and other objects, features and advantages of the present invention will become more apparent from the following detailed description when taken in conjunction with the accompanying drawings, in which:

FIG. 1 is a block diagram illustrating multiple point-of-distribution businesses in communication with a single point-of-sale business, according to an embodiment of the present invention;

FIG. 2 is a block diagram illustrating multiple point-of-sale businesses in communication with a single point-of-distribution business, according to an embodiment of the present invention;

FIG. 3 is a block diagram illustrating a hybrid system which combines features of the embodiments illustrated in FIGS. 1 and 2, according to an embodiment of the present invention;

FIG. 4 is a block diagram illustrating multiple point-of-distribution businesses in communication with multiple point-of-sale businesses, according to an embodiment of the present invention;

FIG. 5 is a flow chart illustrating a method of controlling the inventory of a single point-of-sale business, according to an embodiment of the present invention; and

FIG. 6 is a flow chart illustrating a method of controlling the inventory of a number of point-of-sale businesses, according to an embodiment of the present invention.

### DETAILED DESCRIPTION OF THE INVENTION

Preferred embodiments of the present invention will be described herein below with reference to the accompanying drawings. In the following description, well-known functions or constructions are not described in detail since they would obscure the invention in unnecessary detail.

Overview

The present invention is a fully automated method for making decisions concerning the purchase and return of stock subsequent to an initial buying decision. The initial buying decision may be made manually (i.e., by a human) or automatically (i.e., by a machine). In accordance with the invention, the initial decision introducing any merchandise into any retail establishment for the first time may be influenced or determined by human judgment. This must occur because the initial stock of any retail item cannot be determined by applying objective rules based on actual sales, since, at that point there have been no sales. Some guidance can be derived from the sales experience in the initial few days of similar merchandise. After the initial decision involving some human judgment, all future decisions are automatic, i.e., without human intervention, including correcting the initial human decision if changing it would be advantageous.

Computers are already used in many retail and wholesale operations. Computers at the cash register record sales, keep track of store inventory and assist in making change. In warehouses, they identify the quantity and location of stocked items, store information in an orderly manner and supply that information on request. The present invention suitably includes, in a preferred embodiment, code used directly by one or more applications to process data stored in association with the computer. The computer code implements a set of rules designed to mimic the decisions of an intelligent buyer without human intervention, i.e., the computer becomes in essence a “virtual buyer”. The one or more applications use some combination of sales history, the current date, the day of the week and the store profile to make stocking decisions.

Stock turn is critical to the profitability of retailing. Higher stock turn is achieved by making more decisions more frequently and buying in smaller quantities more often, which makes it easier to keep inventory investment low and stock turn relatively high. While the discount and the price concessions for larger orders, the terms of payment, charges for freight and other aspects of each order may be clearly evident for any retailer's order for any merchandise, the stock turn is not evident. But the set of rules implemented by the present invention to generate orders could be designed to favor stock turn at the expense, if necessary, of the economic rewards for larger orders. The resulting reward of increased return on investment by increasing stock turn can be significant. The need for more, and more frequent, buying decisions and other strong reasons point to the value of a computer assisted method which would make decisions quickly, inexpensively, consistently and automatically.

The present invention is distinguishable from prior art approaches that utilize predictive methods to determine an appropriate stock level. In many retail environments, sales are random events that cannot be predicted with accuracy. Because the system of the present invention responds rapidly to sales events, prediction, even when possible, is not necessary.

The present invention is also distinguishable from prior art approaches which use “just in time” methods to determine an appropriate stock level. Just in time is based on a preexisting knowledge of stock requirements, which is not possible in a retail environment.

The present invention can be implemented in accordance with many embodiments, examples of some of which are described below. In each of the embodiments to be described, it is required that all sales, receipts, returns to the stores by customers and returns that the stores make to their suppliers are recorded to perform the method of the invention. This is required to determine the current inventory value for each item in the system. In addition, periodic checks of the physical inventory are useful to insure the accuracy of the current inventory value against losses, for example from theft. It is noted that while each embodiment describes a data storage location, the specific location is not consequential to the teaching of the present invention. In fact, the location of the data storage and the data processing is not relevant to the implementation of the invention. Either or both could be located at the retailer, at the wholesaler or not localized, using a communication network, such as the Internet for example.

### First Embodiment

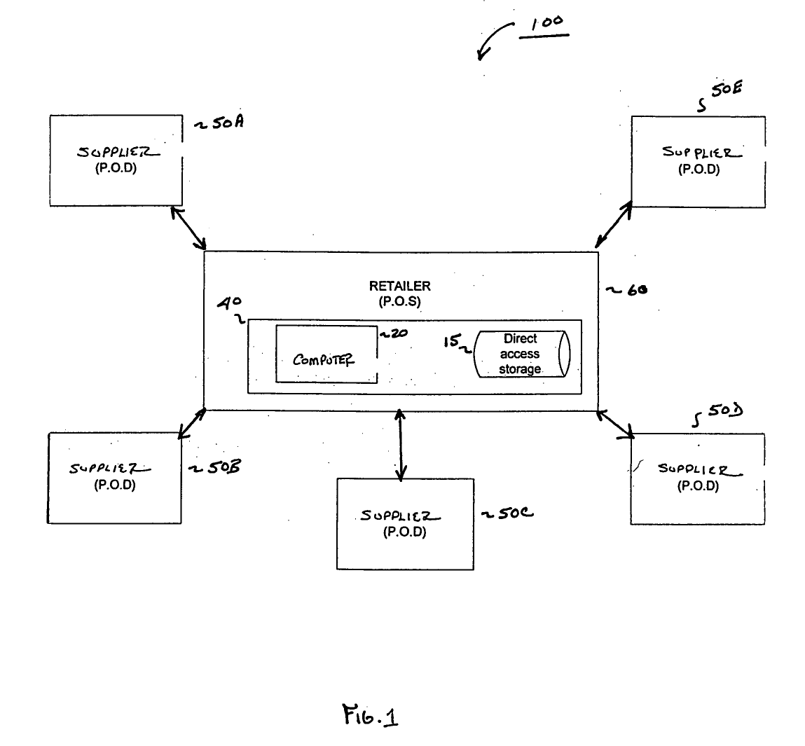

FIG. 1 is an illustration of a first embodiment of the system 100 of the present invention. In this embodiment, the suppliers and retailers are configured in a star topology. Star topologies are well known in the field of networking, for example, and describe a configuration whereby a central hub forms a common connection point to a plurality of devices which form the spokes of the star. In the present context of inventory control, situated at the central hub of the star is shown a single point-of-sale (P.O.S) business 60 (i.e., retailer). The P.O.S. 60 is a common connection point to a plurality of point-of-distribution (P.O.D.) businesses 50A-E (i.e., suppliers).

Also shown, associated with the retailer (P.O.S) 60 is a computer 20 which runs the inventory control software of the invention. The inventory control software performs a number of functions including accessing the stored sale and receipt information. The software also accesses current inventory information, and uses a set(s) of rules to generate a target inventory for each item in the automatic buying system. In accordance with the teaching of the present invention, the target inventory is generated by software which mimics the decisions of an ideal buyer. In other words, the software is acting as a “virtual buyer” which implements a set of rules designed to optimize, e.g., the return on investment for some product subject to a set of constraints, e.g., minimizing out of stock situations. The virtual buyer will implement the desired strategy rapidly, consistently and inexpensively. If the current inventory is less than the target inventory, then the automatic buying system (via the inventory control software) automatically generates an order to bring the current inventory to the target inventory. If the current inventory exceeds the target inventory, instructions to return units may be generated.

### Second Embodiment

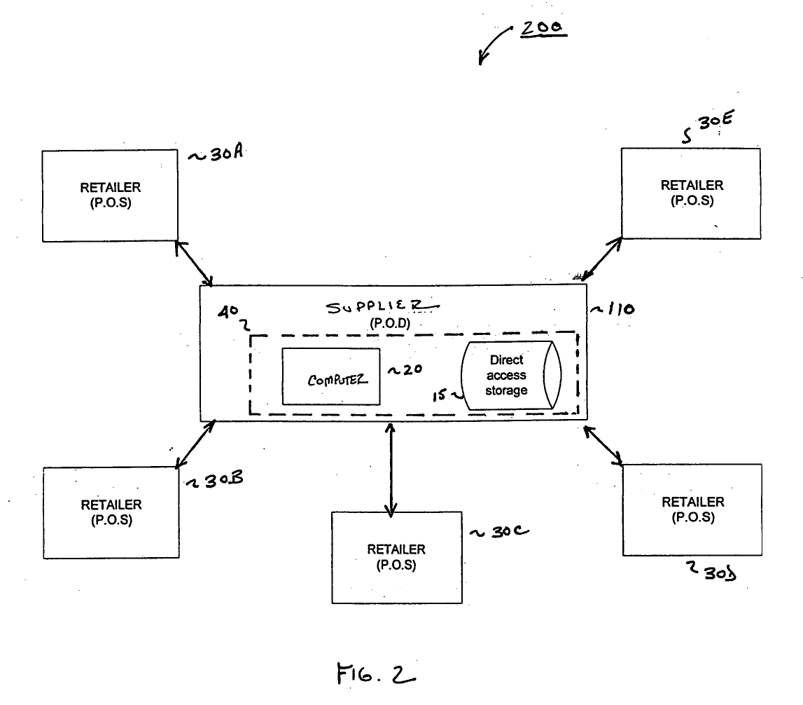

FIG. 2 is an illustration of a second embodiment of the system 200 of the present invention. In this embodiment, the suppliers and retailers are configured in a star topology, similar to that described in the first embodiment, however, in the present embodiment, the central hub of the star is reserved for a single point-of-distribution (P.O.D) business 110 (i.e., supplier) whereby the P.O.D. 110 is the common connection point to a plurality of point-of-sale (P.O.S.) businesses 30A-E. In this embodiment, the inventory control system 40 is centrally situated at a hub, i.e., point-of-distribution (P.O.D) business 110 (i.e., a supplier) that supplies the one or more point-of-sale (P.O.S) businesses (i.e., retailers) 30A-E. The present configuration is in accordance with a star topology in which the supplier (i.e., P.O.D) 110 is situated as a central hub connected to the point-of-sale businesses 30A-E each forming one spoke of the hub.

In this embodiment, each point-of-sale business 30A-E records sales and receipts for each item of inventory and transmits that information periodically (e.g., daily, weekly, or monthly) to a database 15 located at the supplier (P.O.D) 110. The inventory control system 40 further includes a computer 20 which runs a software program to implement a set of rules to determine a target inventory for each item at each retail (P.O.S.) location. The software compares the periodically transmitted sales and receipt information from each retailer (P.O.S) 30A-E with the current inventory for each stocked item that is also maintained in a system database 15. In accordance with the method, if the current inventory for an item is less than the target inventory, then an order for more units of that item is generated to bring the current inventory to the target inventory. If the current inventory exceeds the target inventory for an item, then instructions to return units of that item from a retail location (P.O.S. 30A-E) to the supplier (P.O.D) 110 may be generated.

### Third Embodiment

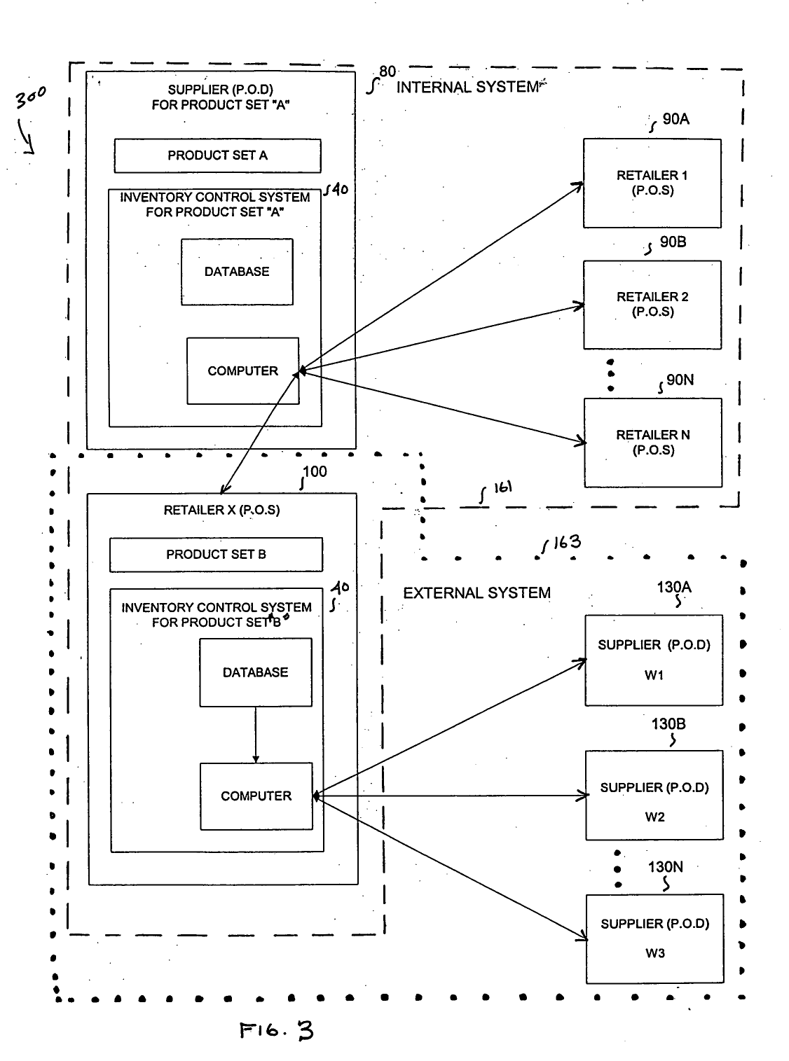

FIG. 3 illustrates a third embodiment of the invention. This embodiment describes a hybrid system 300 which combines features of the first and second embodiments. In particular, system 300 includes two subsystems 161, 163 where subsystem 161 is configured in accordance with the topology of FIG. 2. That is, subsystem 161 includes a single supplier (P.O.D) which supplies product to a plurality of retailers (P.O.S.s) 90A-N, 90X. Subsystem 161 is distinguishable from the configuration of FIG. 2 in that it concerns only a particular product set, i.e., product set “A”.

Also shown is subsystem 163 which is configured in accordance with the topology of FIG. 1. That is, subsystem 163 includes a single Retailer (P.O.S), i.e., Retailer X, that receives product from a plurality of suppliers (P.O.S.s) 90A-N. Subsystem 163 is distinguishable from the configuration of FIG. 1 in that it concerns only a particular product set, i.e., product set “B”.

Retailer X is shown to further include the inventory control system 40 as a component of subsystem 163. With reference to subsystem 163, Retailer X purchases product set “B” from one or more outside suppliers identified as 130A-N (P.O.D.s). As shown, Retailer X represents the linking node between the internal system 161 and the external system 163 comprised of external suppliers 130A-N.

A hybrid system 300 as illustrated in FIG. 3, finds practical application in situations where there exists special stock (e.g., product set “B”) whose purchasing procedures do not comply with the purchasing procedures employed for the majority of stock (e.g., product set A) in the internal system 161.

### Fourth Embodiment

The system of the present invention could also be implemented by a business that includes multiple point-of-sale locations and one or more point-of-distribution locations. The purpose of including the present embodiment is described with reference to an illustrative example to follow entitled: A Bookstore Chain.

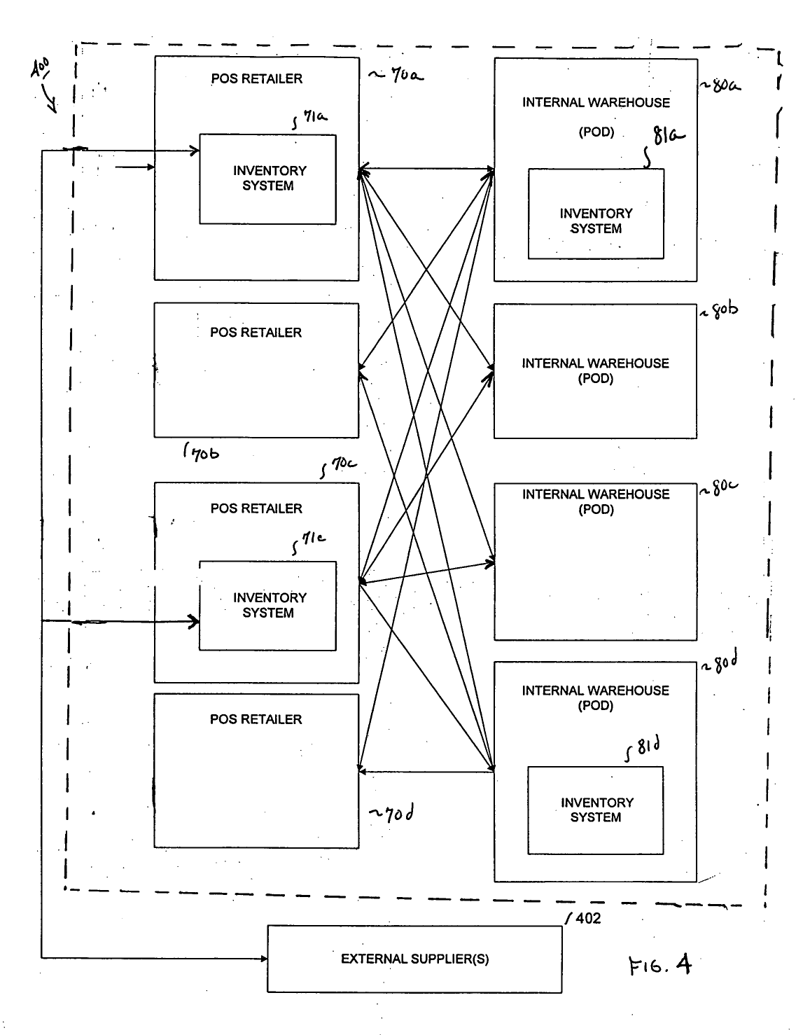

FIG. 4 is an illustration of a system 400 configuration which includes four P.O.S. retailers 70A-D and four P.O.D suppliers 80A-D. The number of suppliers and retailers chosen is arbitrary for the purpose of illustrating the present embodiment. A greater or lesser number of retailers and suppliers may be used in alternate configurations.

As shown in FIG. 4, a subset of the P.O.S. retailers further include P.O.S. systems. Specifically, P.O. S retailers 70A and 70C further include P.O.S systems 71A and 71C, respectively. Similarly, a subset of the P.O.D. suppliers further include P.O.D. systems. Specifically, P.O.D suppliers 80A and 80D further include P.O.D systems 81A and 81D, respectively. The system 400 further includes one or more external suppliers identified by numeral 402 for supplying product to the P.O.S. retailers 70A-D.

In this embodiment, sales and receipts recorded at each point-of-sale location 70A-D are stored in a database along with the inventory levels for each item. For each 20 item, a target inventory is calculated. If the current inventory is less than the target inventory at a particular point-of-sale location, then instructions are generated for supplying additional units of that item to be shipped from the one or more point-of-distribution locations 80A-D to the particular point-of-sale location generating the request.

If the current inventory exceeds the target inventory at a particular point-of-sale location, then instructions to return units from that point-of-sale location to one or more of the point-of-distribution locations may be automatically generated.

### Further Embodiments: Suppliers, Distributors, etc.

In addition to making a point-of-sale (P.O.S) location operate more efficiently, the invention could also be used to help suppliers, distributors, and similar businesses improve their performance. For such a business, the invention could also be used to maintain an appropriate inventory of products as previously described. The sets of rules used in this situation might, however, be different from the set of rules used in a point-of-sale (P.O.S.) business. For example, since the typical business of this type must obtain inventory from a wide variety of sources each with a different delivery time, the set of rules in this case could include a parameter for each product that represents the delivery time. A set of rules could be implemented for each product. Each set of rules would automatically order products with the assigned delivery time properly taken into account.

For example, if a product A requires a two week delivery time, the set of rules might maintain a minimum inventory equal to a three week supply of product A. The orders for each order period would be calculated as follows: The target inventory might be defined as the sum of the sales for the last three weeks. If the target inventory is greater than the current inventory, order enough to meet the target. If the target inventory is equal to or less than the current inventory, do not order.

As a further example, if product B requires only a two day delivery time then one might choose a set of rules to maintain a minimum inventory equal to a three day supply of product B. Orders would then be calculated as follows. The target inventory might be defined as the sum of the sales for the last three days. If the target inventory is greater than the current inventory, order enough to meet the target. Otherwise, if the target inventory is equal to or less than the current inventory, do not order.

Of course in any of the described embodiments, the business owner or operator has the option to override the system at any time. The system will have the ability to both know about the occurrence of a local override and to revert to computer controlled buying when the local override expires.

Although the invention is applicable to a wide variety of point-of-sale businesses, the invention will be further described in the context of an independent retail bookselling business.

### FIRST ILLUSTRATIVE EXAMPLE

### Bookstore

In the present example, it is assumed that books can be supplied from a supplier on a daily basis. It is noted that the time period used in another implementation might be different, but in this case the method of the present invention is performed daily:
a) How many units of each title should be delivered from the supplier to the bookstore?
b) What specified books should be returned from the bookstore to the supplier?

Daily supply (and/or returns) of merchandise permits the inventory at the retail point to be controlled without prediction of future needs. Reaction to the current day's experience (or current week's experience, or some other continuous recent time period) is sufficient to keep the inventory and supply system under control. A continuous time period is defined herein as a number of consecutive days in which a business entity is open for business.

In this example, the calculation is done at the retail location, as shown in FIG. 2. In the present example a single set of mathematical rules is used for all books in the retail bookstore. In this example, the same set of rules is applied to every title. However, it is noted that in alternate implementations, it is contemplated that different sets of rules may be applied to different categories. For example, the set of rules for hard cover books might be different from the set of rules for paperbacks. A rule set (e.g., rules 1-3) for hard cover books could be stated as:

RULE 1: Is the sum of sales over last 3 days ≧1;
If yes→target inventory=sum of sales over last 3 days;
If no→target inventory=1;

Accordingly, after application of the first rule, a second rule is applied. In accordance with the second rule, the current inventory is checked to determine whether the target inventory is less than or greater than the current inventory. If the target inventory is determined to be greater than the current inventory, additional copies are ordered to satisfy the target inventory. Otherwise, if it is determined that the target inventory is less than or equal to the current inventory, no orders for additional copies are generated. This second rule is succinctly stated as:

RULE 2: Is target inventory>current inventory
If yes→order additional copies to satisfy target;
If no→do not order additional copies;

A third rule may then be applied, stated as:

RULE 3: Is current inventory>(target inventory+3)
If yes→return all excess copies;
If no→do not return any copies;

This rule will minimize the danger that a sale on the following day will fully deplete existing inventory. Therefore, the inventory at the retail bookstore should be one unit or the total number sold over the past three days, whichever is greater. The automated system is flexible in that the supply of any specified merchandise item at the retail point may be increased, decreased or reduced to zero at a days notice.

While each individual ordering decision made by the automated system is not reviewed by a human before it is applied, the overall performance of the computer system is clearly reviewable and adjustments for improvement can be made easily. Case by case modification is not desirable for a number of reasons, including: (1) the factors to be weighed are too numerous and complicated; (2) the amount of money at stake in any one decision is usually too small to warrant such attention; (3) the drain on management time would be too great.

For example, if it is determined upon review that the overall results are not satisfactory, perhaps in gross income or in return on investment, any of the parameters in the system can be changed (e.g., the maximum inventory on any item can be changed from the total sale over the previous three days to the total sale over four or five or six days and so on; the minimum inventory on any item can be changed from one unit to two units, etc.)

A further advantage of the method and system of the present invention is that before any such changes are actually implemented, the history of sales and inventory can be tested against these possible changes to see whether there would have been any difference in results, favorable or unfavorable.

In actual practice, a retail bookseller will likely want to use more than one set of rules for the titles in the bookstore. For example, some books might be seasonal books and a set of rules could be implemented for those titles accordingly.

Illustrative Flow Chart: Single P.O.D./Multiple P.O.S.

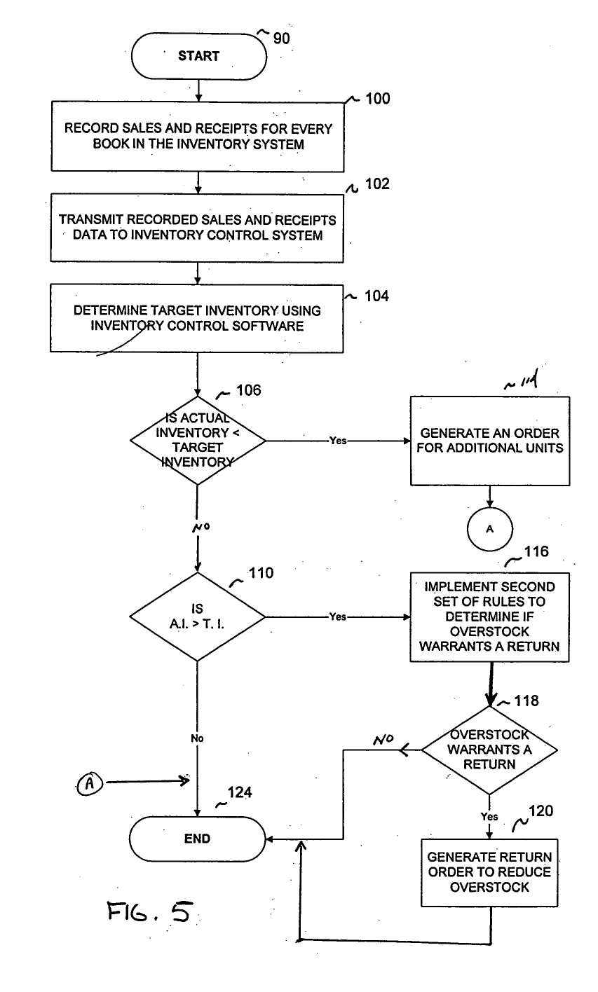

FIG. 5 is a flow chart illustrating a method of controlling the inventory of a point-of-sale business according to the second embodiment of the present invention. The illustrative flowchart is described in the context of a retail book seller wherein the process described in the flowchart of FIG. 5 is applicable to every book in the inventory system.

Referring to FIG. 5, the method for controlling inventory is initiated at step 90. At step 100, the point-of-sale business, (i.e., the bookseller) records all the sales and receipts for the units of merchandise sold or returned to the store. This information is then transmitted to the inventory control system in step 102. Data and/or instructions may be transmitted by Courier, Internet, mail, electronic means, telephone, email, or any other transmission facility that may be convenient or economical. The program implementing the system can be located in the store, in a remote location or via the Internet. In step 104, the inventory control software is implemented to determine a target inventory for each unit of merchandise. Then, in step 106, the target inventories are compared to the actual inventories of the bookseller. If the actual inventory is less than the target inventory in step 106, an order is generated for the point-of-distribution business (the book supplier) to ship more units to the store in step 114 and the process then ends for this item at step 124. Otherwise, the process continues at determination step 110. At step 110, it is determined whether the actual inventory is greater than the target inventory. If so, another set of rules is implemented to determine whether the over-stock situation warrants a return order at step 116. At step 118, if it is determined that the overstock warrants a return, an order is generated to reduce the overstock, step 120. If at step 118 it is determined that the overstock does not warrant a return, the process ends for this item at step 124. If it is determined at step 110 that the actual inventory is not greater than the target inventory, the process ends at step 124.

### SECOND ILLUSTRATIVE EXAMPLE

### A Bookstore Chain

Another specific example might be the “bookstore chain”, in which the owner of multiple retail stores uses the present invention to operate one or more depositories from which books, sometimes only a portion of the possible titles and/or only a portion of the copies of a title, are shipped to the individual stores. In this case, ownership does not change between shipping point and the store. Further, the books usually become the property of the chain when they go from the publisher to the chain's depositories.

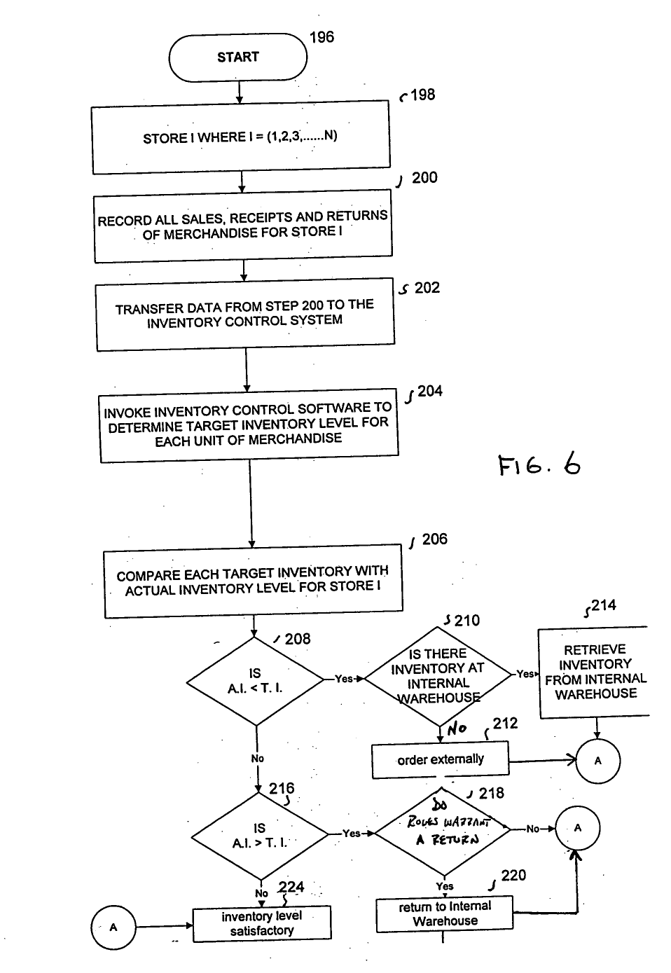

FIG. 6 is a flow chart illustrating a method of controlling the inventory of each point-of-sale location in a bookstore chain in accordance with the fourth embodiment. The steps illustrated in the flowchart are followed for every store and for every book in the inventory system.

The process starts at step 196 and at step 198, loops through the process for each bookstore in the chain. At step 200, for each bookstore in the chain, all the sales, receipts and returns of the books in the system are recorded.

A number of point-of-sale locations, the stores in the bookstore chain in the example, record all the sales, receipts and returns for the units of merchandise sold, received or returned to the stores in step 200. This information is then transmitted to the inventory control system in step 202. In step 204, the inventory control soft-ware is implemented to determine a target inventory for each unit of merchandise in the system in each store. Then, in step 206, the target inventories are compared to the actual inventories in each store. If in an individual store any actual inventory is determined to be less than the target inventory in step 208, it is determined in step 210 whether there are any books available at the internal warehouse. If yes, an order to transfer books is generated in step 214. The process then ends for this item at step 224. If it is determined in step 210 that there are no books available for transfer from the internal warehouse, an order is generated to an external supplier at step 212 and the process ends for this item at step 224.

If in step 208 the actual inventory is determined not to be less than the target inventory, the process continues to step 216. Step 216 is a determination step to determine whether the actual inventory is greater than the target inventory. If so, the process continues to step 218.

Step 218 is a step to determine whether the overstock (i.e., actual>target) warrants a return to the internal warehouse. If yes, an order to transfer the excess units to the internal warehouse is generated in step 220 and the process ends for this item in step 224. If in step 218 it is determined that the overstock does not warrant a return, then the process ends for this item at step 224.

If in step 216 it is determined that the actual inventory is not greater than the target inventory, the process ends for this item at step 224.

The most obvious difference in the method as illustrated in FIG. 6 as compared to the method illustrated in FIG. 5 is that instead of generating orders to an external supplier immediately, the system first checks the internal warehouse for availability.

Those skilled in the art will readily recognize that these and various other modifications, arrangements and methods can be made to the present invention without strictly following the exemplary applications illustrated and described herein, and without departing from the spirit and scope of the present invention.

1-13. (canceled)

14. A system for automatically controlling an inventory level for a plurality of merchandise items supplied by at least one point-of-distribution business for distribution to at least one point-of-sale business, the system comprising:
means for recording information pertaining to said plurality of merchandise items to determine a current inventory and a sales history for each of said plurality of merchandise items;
means for determining a target inventory for each of said plurality of merchandise items based on a first predetermined function;
means for comparing the target inventory to the current inventory for each of said plurality of merchandise items;
means for performing no action if the target inventory is determined to be equal to the current inventory; and
means for performing one of no action and at least one action if the target inventory is determined to be not equal to the current inventory.

15. The system of claim 14, wherein the recorded information includes at least one of information corresponding to merchandise items received, sold and returned, and adjustments to stocked merchandise items.

16. The system of claim 15, wherein the merchandise items returned include merchandise items returned to said point-of-sale businesses and merchandise items returned from said point-of-sale businesses to said point-of-distribution businesses.

17. The system of claim 15, wherein the adjustments to said stocked merchandise items are based on physical inventory.

18. The system of claim 14, wherein the system is located at the point-of-sale business.

19. The system of claim 14, wherein the system is located at the point-of-distribution business.

20. The system of claim 14, wherein the system is located at a location other than said point-of-distribution business and said point-of-sale business.

21. The system of claim 14, wherein the system is located at at least one of the point-of-distribution business, the point-of-sale business and a location other than said point-of-distribution business and said point-of-sale business.

22. The system of claim 14, wherein the system is implemented as an Internet based Website.

23. The system of claim 14, wherein the first predetermined function is based on the recorded information occurring over a predetermined time interval and at least one of a current date, a day of the week, and a profile of said at least one point-of-sale business.

24. The system of claim 23, wherein the predetermined time interval is a continuous time interval.

25. The system of claim 24, wherein the continuous time interval is an integer multiple of one day.

26. The system of claim 14, wherein the means for performing at least one action further comprises:
means for automatically shipping inventory from the at least one point-of-distribution business to the at least one point-of-sale business in which the target inventory associated with the at least one point-of-sale business is determined to be greater than the current inventory to thereby adjust the current inventory;
means for generating a purchase order from the at least one point-of-sale business to the at least one point of distribution business in which the target inventory associated with the at least one point-of-sale business is determined to be greater than the current inventory to thereby adjust the current inventory; and
means for generating a return order from the at least one point-of-sale business to the at least one point of distribution business in which the target inventory associated with the at least one point-of-sale business is determined to be less than the current inventory to thereby adjust the current inventory.

27. The system of claim 26, wherein the means for generating a return order, further includes:
means for determining whether to distribute at least one merchandise item from said at least one point-of-sale business to said at least one point-of-distribution business.

28. The system of claim 27, wherein the determining means further includes means for evaluating a second predetermined function.

29. The system of claim 28, wherein the second predetermined function is based on at least one of a current date, a day of the week and a profile of said point-of-sale business.

30. The system of claim 14, wherein the means for performing one of no action and at least one action further includes:
means for exchanging at least one merchandise item between the at least one point-of-sale business which has an associated current inventory greater than a target inventory determined for said at least one point-of-sale business and at least one other point-of-sale business which has an associated current inventory less than a target inventory determined for said at least one other point-of-sale business.

31-46. (canceled)
